(19) United States
(12) Patent Application Publication
(10) Pub. No.: US 2022/0378060 A1
(43) Pub. Date: Dec. 1, 2022

(54) SYSTEM AND METHOD FOR ACCELERATING EXTRACTION OF INGREDIENTS INTO A PRODUCT

(71) Applicant: Robert Christoper RUETER, Las Vegas, NV (US)

(72) Inventor: Robert Christopher RUETER, Las Vegas, NV (US)

(21) Appl. No.: 17/625,652

(22) PCT Filed: Feb. 19, 2020
(86) PCT No.: PCT/US2020/018777

§ 371 Date: Jan. 7, 2022

(51) Int. Cl. A23F 5/26; A23F 3/18; A47J 31/18; A47J 31/44

(52) U.S. Cl. CPC A23F 5/26; A23F 3/18; A47J 31/18; A47J 31/4403

(57) ABSTRACT

A system and method for extraction is provided. The method includes filling a chamber of a vessel at least partially with at least one liquid ingredient. The method also includes diffusing at least one displacement material having a higher molecular mass than terrestrial air and a lower molecular mass than the liquid ingredient through at least one port located adjacent to or along a bottom surface of the vessel for releasing oxygen from the liquid ingredient. The method also includes discharging the released oxygen from the chamber through an outlet adjacent to or along a top surface of the vessel to provide a substantially anaerobic atmosphere. The method also includes introducing at least one additional ingredient into the chamber of the vessel. The method also includes agitating the at least one liquid ingredient and the at least one additional ingredient while maintaining the anaerobic atmosphere in the chamber.

### TECHNICAL FIELD

A system and method for accelerating extraction of ingredients into a product. More particularly a system and method for extracting an ingredient, such as coffee grounds, into liquid(s) such as water that includes the introduction of a displacement material that has a molecular weight that is greater than that of terrestrial air and less than the liquid(s) ingredient(s) into a bottom surface of a vessel in order to dislodge and displace dissolved oxygen and minimize oxidation of the ingredient during extraction in order to allow agitation thereof without negatively impacting characteristics of the product while improving an efficiency of the cold brewing process.

### BACKGROUND

Techniques are known for extracting flavors and compounds from ingredients such as coffee, tea and herbs into a liquid such as water in order to create a final beverage/product. A common “hot brewing” technique involves infusing the ingredient with a hot liquid, wherein the high temperature of the liquid provides a quick extraction process. A “cold brewing” technique is also known in which the ingredient is combined with a cooler liquid for a period of time until a desired amount of extraction has occurred. However, due to the lower temperature, cold brewing requires a much longer extraction process than hot brewing. There remains a need for improved extraction techniques.

### SUMMARY OF THE INVENTION

According to an aspect of the disclosure, a system of extraction is provided. The system includes a vessel having a top surface and a bottom surface and defining a chamber for containing at least one liquid ingredient and at least one additional ingredient. The system also includes an agitator for agitating the at least one liquid ingredient and the at least one additional ingredient. At least one port is defined adjacent to or along the bottom surface and is connected to a source of a displacement material having a higher molecular mass than terrestrial air and a lower molecular mass than the at least one liquid ingredient. A diffusion mechanism may be coupled with the at least one port for distributing the at least one displacement material through the at least one liquid ingredient contained in the chamber in order to minimize dissolved oxygen in the at least one ingredient.

According to another aspect of the disclosure, a method for extraction is provided. The method includes filling a chamber of a vessel at least partially with at least one liquid ingredient. The method also includes diffusing at least one displacement material having a higher molecular mass than terrestrial air and a lower molecular mass than the liquid ingredient through at least one port located adjacent to or along a bottom surface of the vessel for releasing dissolved oxygen from the liquid ingredient. The method also includes discharging the released oxygen and any terrestrial air from the chamber through an outlet adjacent to or along a top of the vessel to provide a substantially anaerobic atmosphere in the chamber. The method also includes introducing at least one additional ingredient into the chamber of the vessel. The method also includes agitating the at least one first liquid ingredient and the at least one additional ingredient while maintaining the anaerobic atmosphere in the chamber.

Accordingly, the subject system and method provide extraction, e.g., cold brewing, of products, such as coffee, in a short period of time, without affecting flavor characteristics of the product and shelf-life due to oxidization. More particularly, because oxygen is displaced from the liquid by the diffusing material that has a higher molecular mass than terrestrial air and a lower molecular mass than the liquid ingredient (e.g., water), then further displaced once it surfaces from the liquid ingredient, the liquid ingredient and additional ingredient (e.g., coffee grounds) may be agitated with minimal damage from oxidation, thus speeding up the extraction process. Furthermore, because the displacement material has a greater atomic mass than terrestrial air, it displaces the oxygen upwardly, thus allowing the oxygen to escape from a top surface of the vessel. This is unlike other displacement materials, such as nitrogen, which have a lower atomic mass than terrestrial air and thus sit higher than terrestrial air within the vessel, and thus inhibit the ability of oxygen/air to escape the vessel as they displace the terrestrial air at the top of the vessel while maintaining a layer of terrestrial air upon the surface of the ingredients. Additionally, because the displacement material is emitted from along, or adjacent to the bottom surface of the vessel, it travels upwardly through the liquid ingredient, facilitating removal of volumes of dissolved oxygen.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a schematic of an example embodiment of a system for accelerating extraction of ingredients into a product;

FIG. 2A is a right-side cutaway view of a vessel of the system for accelerating extraction of ingredients into a product;

FIG. 2B is a left side cutaway view of a vessel of the system for of accelerating extraction of ingredients into a product;

FIG. 2C is a bottom view of a vessel of the system for accelerating extraction of ingredients into a product;

FIG. 2D is a top view of a vessel of the system for accelerating extraction of ingredients into a product;

FIG. 3 is a top view of an example diffuser of the subject system for accelerating extraction of ingredients into a product; and

FIG. 4 is a flow diagram of a method of accelerating extraction of ingredients into a product.

### DESCRIPTION OF THE EXAMPLE EMBODIMENT

In the following description, details are set forth to provide an understanding of the present disclosure. In some instances, certain systems, structures and techniques have not been described or shown in detail in order not to obscure the disclosure.

Referring to the figures, wherein like numerals indicate corresponding parts throughout the several views, a system 10 and method for extraction 10, more particularly, a system 10 and method for extraction of one or more ingredients 11 (such as coffee or tea) into a liquid ingredient (such as water) 13 is generally shown. The liquid ingredient 13 may alternatively be other compositions, such as a plasma or a foam. The system 10 includes a vessel 12 that extends between a top surface 14 and a bottom surface 16 along a sidewall 18 and defines a chamber 20. The top and bottom surfaces 14, 16 are shown to have a generally conical shape, however, it should be appreciated that they could have other shapes and arrangements. Furthermore, the top surface may alternatively be a displacement material 15, such as a liquid, gas, or plasma, so long as it provides the ability to maintain an anaerobic environment for the ingredients within the vessel 12. The term “displacement material” herein refers to a liquid, gas or plasma that has a higher molecular mass than terrestrial air and a lower molecular mass than the liquid ingredient 13.

Various components of the vessel 12 are connected to a controller 17 for providing automatic or manual control thereof. Various types of controllers may be employed, as would be understood by one of ordinary skill in the art.

The top surface 14 of the vessel 12 defines a loading valve 22 for receiving an ingredient 11 or combination of ingredients including, but not limited to, coffee grounds, tea or herbs. As such, any combination of ingredients 11, 13 that require the removal of dissolved oxygen during production may benefit from the system and methods described herein. The loading valve 22 may be a manway or other style hatch. The loading valve 22 may be connected with a hopper 24 and associated release valve 25 that may be purged with the displacement material 15 such as argon or another non-reactive gas to create an anaerobic environment therein for holding the ingredient 11 prior to delivery into the vessel 12. Although the hopper 24 is shown in spaced relationship with the loading valve 22, it may alternatively be mounted directly on the loading valve 22. The loading valve 22 may be automatically or manually controlled by the controller 17. The bottom surface 16 of the vessel 12 defines a discharge port 26 for outputting ingredients/the product. The discharge port 26 may be automatically or manually controlled by the controller 17.

The sidewall 18 defines a liquid port 28 for receiving at least one liquid ingredient 13, such as water, into the chamber 20. A fill valve 30 is coupled with the liquid port 28, which is connected to a liquid line 32 for receiving the liquid ingredient 13 into the vessel 12. The fill valve 30 may be automatically or manually controlled by the controller 17. A liquid sensor 34 is located in the chamber 20 and may be connected to the controller 17 for detecting a liquid level within the vessel 12. The liquid sensor 34 may include various devices such as an inline flowmeter on the liquid input, sonic, optic, conductive sensors or a manual observation window such as a port or sight glass with indicators. Filling of the vessel 12 may be performed manually or through other means. It should be appreciated that the liquid ingredient 13 may be introduced, in any measured fashion, into the vessel 12.

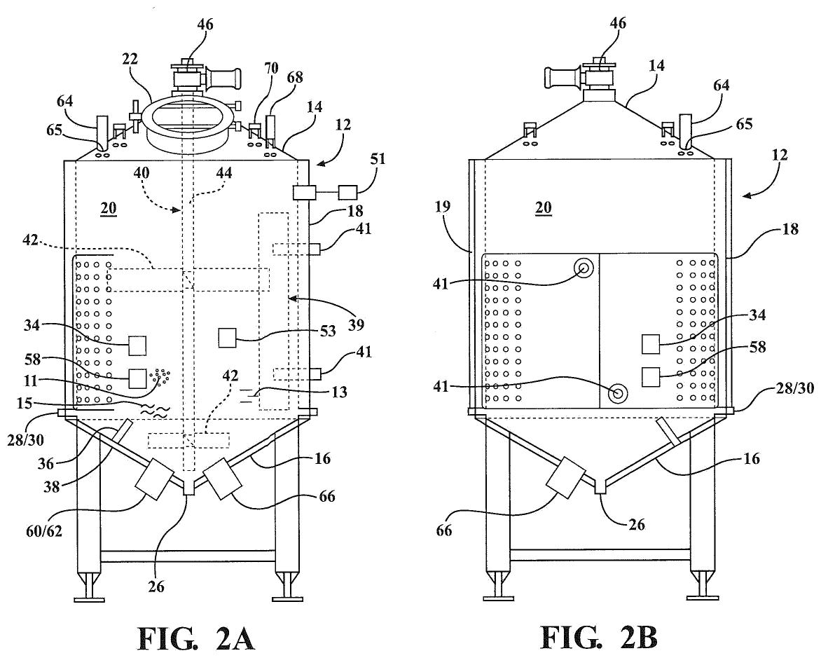

The sidewall 18 further defines a probe well 36 that extends into the chamber 20. The probe well 36 receives a temperature sensor 38 for detecting a temperature in the chamber 20 (either of the liquid or air/gas above the liquid). The temperature sensor 38 may extend into the chamber 20 in other manners. The temperature sensor 38 may be connected to the controller 17 for providing readings thereof to the controller 17. A heat exchanger 39 is provided in the chamber 20 for managing a temperature in the chamber 20. The heat exchanger 39 may also be used to manage the temperature of the ingredients 11, 13 within the vessel 12. The heat exchanger 39 may be automatically or manually controlled by the controller 17. The heat exchanger includes a pair of refrigerant/steam ports 41 and an associated refrigerant/steam valve 43 for allowing the refrigerant to be passed into and out of the vessel 12. As shown in FIG. 2B, a jacket 19 may surround an outer perimeter of the vessel 12 for insulating the vessel 12. The refrigerant/steam ports 31 and associated refrigerant/steam valve 43 may pass through the jacket 19. Additional connections may be provided for allowing the ingredients 11, 13 to be plumbed in and out of the heat exchanger 39. The heat exchanger 39 works in partnership with the jacket 19. The integration of the heat exchanger 39 and jacket 19 allows for greater environmental manipulation of the ingredients 11, 13 within the vessel 12 and during the process within the present application. It should be appreciated that the temperature sensor 38 and heat exchanger 39 allow for a large spectrum of extractions through added, controlled, variables. The use of the heat exchanger 39 jacket 19 allows the operator to experiment in extractions across a full temperature range with the ability to quickly heat, and cool, the ingredient(s) 11, 13. According to an embodiment, the liquid ingredient 13 may be maintained at a temperature of below 90 degrees Fahrenheit and above 32 degrees Fahrenheit throughout the extraction process in order to provide a “cold brewing” process.

An agitator 40 is located inside or outside of the chamber 20 and is configured to agitate/mix the ingredients 11, 13 within the chamber 20. The agitator 40 may be automatically or manually controlled by the controller 17. In the disclosed embodiment, the agitator 40 includes two propellers 42 that are connected along a shaft 44 and are configured to rotate within the chamber 20 with the shaft 44. A motor 46 is located at the top surface 14 of the vessel 12 and is coupled with the shaft 44 for automatically rotationally driving the propellers 42. Alternatively, the agitator 40 may include a manually driven handle. Any number or configurations of propellers could be employed.

The agitator 40 may take various other forms. For example, the agitator 40 may include other mechanical devices such as paddles or fins that move the ingredients 11, 13 in a mechanical fashion. The agitator 40 could also consist of various devices that shake, vibrate, turn or otherwise stimulate the vessel 12 and/or ingredients 11, 13 contained therein to provide movement thereof.

The agitator 40 may also be one or more circulation lines 48 that extend into the chamber 20. The circulation lines 48 may be connected to a circulation pump 50 outside or inside the chamber 20. If inside the chamber 20, the pump 50 may be submergible such that it may be surrounded by the ingredients 11, 13. The circulation lines 48 are configured to agitate the ingredients 11, 13 by cycling the liquid ingredient 13 therein at a predetermined (range of) velocity(ies) and pressure(s)d.

The agitator 40 may also include chamber lines 52 that circulate through a series of oxygen voided supplementary vessels 54. The supplementary vessels 54 may have the capability of restricting the passage of ingredients 11, 13 such as by way of perforated false bottom, a mesh, a one-time use filter of the same or varying porosity, or an inline separator. The ingredients 11, 13 could also be pumped from one point in the supplementary vessels 54 into others. Furthermore, the ingredients 11, 13 may be transferred between any of the vessels 12, 54. A plurality of valves 55 and sensors 57 are located between the vessel 12 and the supplementary vessels 54 and connected to the controller 17 for controlling fluid flow therebetween. In this embodiment, ingredients 11, 13 may be added to any of the vessels 12, 54 as the fluid flows through each bed of ingredients 11, 13 and circulates from vessel to vessel 12, 54.

The agitator 40 may also include ports 56 provided along various locations of the vessel 12 for modulating a pressure in the vessel 12 by providing or removing a gas, such as the displacement material 15, from the chamber 20. A circulation pump 51 may be used to provide the gas at various pressures. The gas may create turbulence to provide agitation. Variables that may fine tune this process include aperture size of the input port 56, gas/pump pressure, angle of entry and input port 56 location.

The agitator 40 may further include a device 53 that provides the application of various frequencies, a current, or sonic means to stimulate locomotion of the ingredients 11, 13.

Throughout the extraction process, various sensors 58 or manual tests may be used to confirm extraction. The extraction is considered complete when set values are in a user-defined range. The sensors 58 may be connected to the controller 17 for passing data thereto. The sensors 58 may be designed to test variables including: Brix, PH, TDS, soluble yield, extraction percentage, turbidity, and undissolved solids, and/or weight. Such sensors 58 may include chromatography, refractometer, spectrograph sensors or other methods of visual, audio, or chemical constituent analysis.

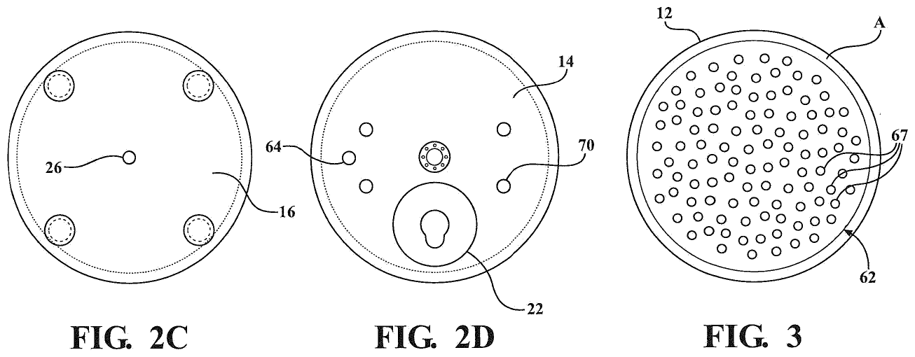

At least one port 60 is defined along the bottom surface, or adjacent thereto. Furthermore, according to this embodiment, at least one diffusing mechanism 62, is coupled to the port 60 and/or in the chamber 20 for introducing the displacement material 15 into the chamber 20 to purge dissolved oxygen from the liquid ingredient 13 prior to introducing further ingredient(s) 11 into the chamber 20 and/or after the further ingredient(s) 11 have been added and/or during agitation of the liquid ingredient 13 and additional ingredients 11. As shown in FIG. 3, the diffusing mechanism 62 may include a plurality of perforations 67 secured in the port 60, and/or in the chamber 20, for introducing the displacement material 15 into the chamber 20. Additionally, a diffusion technique could also involve manipulating the velocity of the displacement material 15 entering the chamber 20 in such a way to generate diffusion. The selected velocity or range of velocity of the introduced displacement material 15 depends on the physical characteristics of the chamber 20 and vessel 12. According to the example embodiment, the displacement material 15 is argon, however, various other gasses, liquids or plasmas may be used, but they should have a higher molecular mass than terrestrial air and a lower molecular mass than the liquid ingredient 13. The diffusing mechanism 62 may be connected to the controller 17 for providing automatic or manual control thereof. It should be appreciated that various diffusing mechanisms could be employed.

One embodiment of a diffusion method is shown in FIG. 3, in which the vessel 12 may have a first area A in a horizontal direction, and the diffusing mechanism 62 extends across at least a majority of the first area A such that it propels the displacement material 15 across the bottomside of the vessel 12 through substantially an entire volume of the ingredient(s) 11, 13 in order to distribute the displacement material 15 evenly across the ingredient(s) 11, 13 in the chamber 20. The diffusing mechanism 62 may include a valve or solenoid 63 that is connected to the controller 17 for automatically or manually starting and stopping the flow of the displacement material 15. Alternatively, the diffusing mechanism 62 may include a manually controlled valve. The diffusing mechanism 62 may include a diffusion stone with a range of materials and sizes and may be made of various materials such as ceramic and stainless steel. The diffusing mechanism 62 may also include a perforated but otherwise solid membrane (semi-permeable), such as a mesh screen. The perforations 67 may range in size and may be of a large range to accomplish the same purpose of distribution of the displacement material 15 through the liquid and/or other ingredients 11, 13. Ultimately, the preferred diffusion method will be defined by the shape and/or other physical characteristics of the vessel 12 and the elements contained within the chamber 20 prior to the determination of the ingredients 11, 13 and displacement material 15 in use.

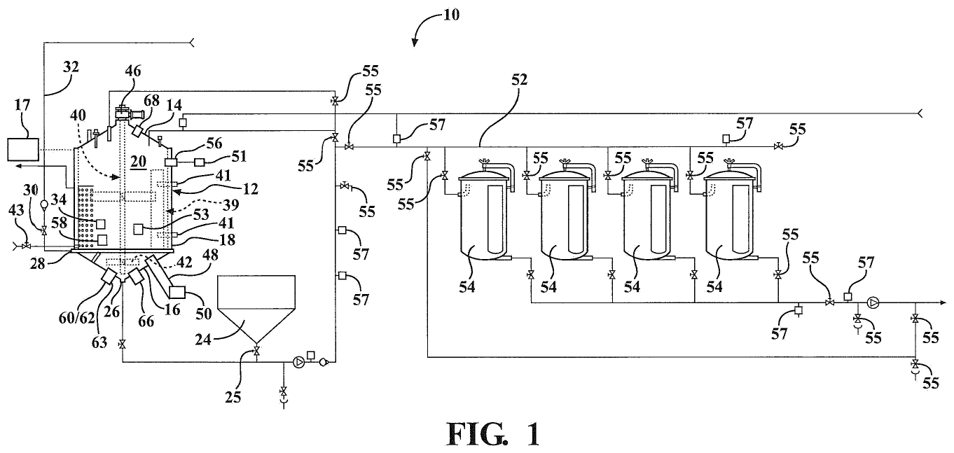

With reference back to FIGS. 1-2D, the top surface 14 of the vessel 12 may define an outlet 65 and an automatic one-way check valve 64 received by the outlet 65 for allowing the release of oxygen from the vessel 12 after entry of the displacement material 15. The check-valve 64 may be connected to the controller 17 for automatic or manual control thereof. A manual valve could also be employed. Alternatively, an open vessel could be employed, wherein a “cover” of displacement material 15 rests upon the surface of the ingredients 11, 13. The particular molecular weight of the cover can vary depending on the density of the ingredients 11, 13 present within the chamber 20 as well as the concentration of dissolved oxygen in combination with the ingredients 11, 13. An environment with minimal airflow outside of the vessel 12 would be required to avoid a disruption of the displacement material 15 and potential contamination of ingredients 11, 13 in the embodiment that the cover is not a solid material.

Optional sensors include one or more submerged dissolved oxygen sensor(s) 66 extending into the chamber 20 adjacent to the bottom surface 16 for monitoring an amount of dissolved oxygen in the ingredients 11, 13. Furthermore, one or more oxygen sensors 68 extend into the chamber 20 adjacent to the top surface 14 for determining an amount of oxygen in the region of the chamber 20 above the ingredients 11, 13. The oxygen sensors 66, 68 may be connected to the controller 17 and may be configured to alert an operator of the presence of oxygen in the chamber 20, and/or for automatically releasing the inert gas through the diffusion mechanism 62 until oxygen is no longer detected or the desired O2 levels are achieved.

A pressure meter 70 may extend into the chamber 20 for measuring a pressure within the chamber 20. The pressure meter 70 may connected to the controller 17 for allowing automatic release of gas through the port 60 and/or input ports 56, or the vacuum of gas from within the chamber 20 such as for maintaining a positive pressure, or vacuum, in the chamber 20

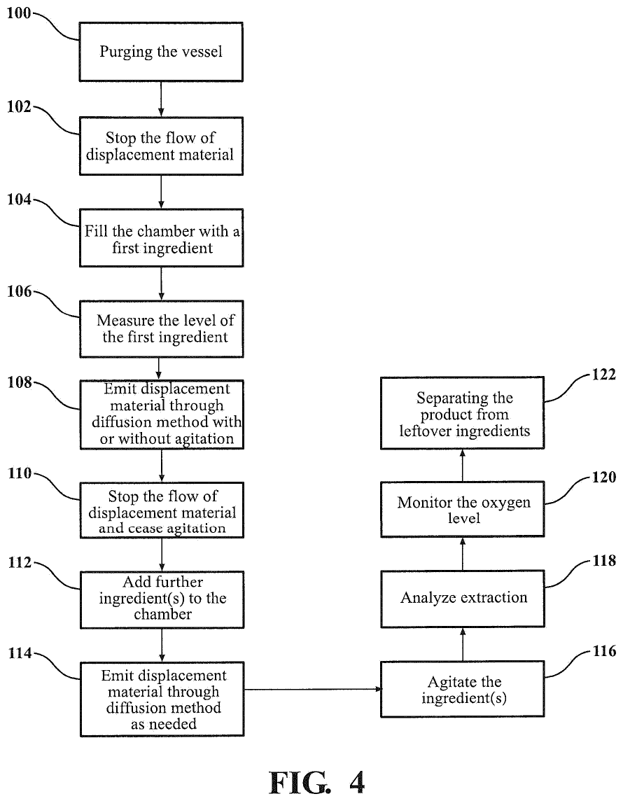

A method of operating the system 10 is also provided. As best shown in FIG. 4, upon an initiation, the method includes 100 purging the vessel 12 of ambient terrestrial air by passing the displacement material 15 into the chamber 20 with the diffusing mechanism 62 and/or the input port 56. Introducing the displacement material 15 may be performed automatically or manually. As the displacement material 15 is introduced, ambient air in the chamber 20 is displaced through the check valve 64, a manual valve, or another pressure release device. The method continues with 102 stopping the flow of the displacement material 15 at a predetermined time, such as when an oxygen level indicated by the dissolved oxygen sensor or oxygen sensor 68, 66 reaches a set threshold or after a predetermined amount of time has passed. In the case of a manual introduction of the displacement material 15, the flow of the displacement material may be automatically or manually shut off at the predetermined time.

In addition to, or separately from 100 emitting the displacement material 15 into the vessel 12 as described above, the step 100 of purging the vessel 12 may also include purging other components of the system 10 of ambient air. For example, all other vessels, lines, hoppers, etc. (everything within the interior of the system 10) may be purged with the displacement material 15. Additional oxygen sensors may be employed in any of these components to alert the operator and/or the controller 17 of the presence of oxygen in any of these components. The purge may be performed through automated solenoids or other actuators. The purge may also be performed manually through valves, check valves, etc.

According to the example embodiment, the check valve 64 is configured to maintain the chamber 20 at a positive pressure, The function of the system 10 can still be achieved without maintaining positive pressure, but the addition of the check valve 64 allows for greater range of potential controlled variables for the operator. The maintenance of positive pressure and oxygen sensors 66, 68 also allows for the use the displacement material 15 to be utilized as the velocity of the displacement material 15 is capable of forcing the oxygen and ambient air through the one-way check valve 64.

Once the vessel 12 is purged of oxygen to a predetermined level, the method continues with 104 filling the chamber 20 with a predetermined amount of at least one of the liquid ingredient 13. The trigger to fill the chamber 20 with liquid ingredient 13 may be initiated based on a reading from the dissolved oxygen and/or oxygen sensors 66, 68. The method continues with 106 measuring the liquid ingredient 13 within the chamber 20 with the liquid sensor 34. Alternatively, the system may operate without the use of sensors, and in particular without the use of the oxygen sensors 66, 68. Measurements could be made through visual or other methods. In the case of oxygen, dissolved or otherwise, the diffusion of the chosen substance will work to varying degrees in the absence of (a) sensor(s).

Once the chamber 20 has been filled with the liquid ingredient 13 to a set point, the method continues with 108 emitting the at least one displacement material 15 through the diffusing mechanism 62. The method continues with 110 stopping the flow of the displacement material 15 once the submerged dissolved oxygen sensor 66 reaches a set point, the second oxygen sensor 68 reaches a set point, and/or a set amount of time has passed. As discussed above, because the diffusing mechanism 62 may be located adjacent to or along the bottom surface of the vessel 12 and may have a large surface area, it is configured to distribute the displacement material 15 across a wide range of the liquid ingredient 13 in both the width (horizontal) and height (vertical) directions, thereby ensuring that a substantially anaerobic atmosphere is provided.

After the oxygen level has reached the predetermined point or the predetermined amount of time has passed, the method continues with 112 adding the additional ingredient(s) to 11 the chamber 20 through the loading valve 22. As noted above, the ingredient(s) 11 may be provided via a hopper 24 that has been purged with the displacement material 15 which is oxygen free like the chamber 20. The hopper 24 may be automated, and in that case, may include a chute that is triggered to open after the oxygen level has reached its predetermined point. On the other hand, the hopper 24 may be manually operated, and in that case, may be manually opened after the oxygen level has reached its predetermined point. The additional ingredient 11 may also be manually introduced to the chamber 20 through a manway or other access portal.

After the additional ingredient(s) 11 has been added to the chamber 20, the method continues with 114 emitting the displacement material 15 into the chamber 20 (before and/or during agitation, discussed below) as needed by the diffusing mechanism 62. For example, the displacement material 15 may be added when the dissolved oxygen sensor or oxygen sensors 66, 68 detect a predetermined level of oxygen in the chamber 20, when it is detected with the pressure meter 70 that a pressure in the chamber 12 drops below a predetermined value, after a predetermined time interval has passed and/or when dissolved oxygen is detected in the slurry.

The method further includes 116 agitating the ingredients 11, 13 with the agitator 40. Agitation may occur via any of the aforementioned mechanisms and methods. Agitating the ingredients 11, 13 may run at a consistent or variable rate to execute various recipes and extraction profiles. The at least one displacement material 15 may be emitted into the chamber with the diffusing mechanism 62 during agitation of the ingredients 11, 13 to further dissolve oxygen therein.

The method may further include 118 analyzing the extraction with the extraction sensors 58. Because of the introduction of the displacement material 15, the ingredients 11, 13 are agitated in a substantially anaerobic environment, thus allowing agitation to increase a speed of extraction of characteristics of the ingredients 11, 13, while preventing oxidization of the ingredients 11, 13 from negatively impacting flavor of the extract, increasing consistency of the product while minimizing a footprint of industrial process lines and minimizing labor. The extraction may alternatively be analyzed without sensors.

The method continues with 120 monitoring the oxygen level in the chamber 20 and emitting the displacement material 15 through the diffusing mechanism 62 as needed. Upon a of the presence of oxygen, the displacement material 15 is introduced with the diffusing mechanism 62 until the oxygen is at least substantially displaced. Again, displacement can occur via the automatic check valve 64, or a manual valve. The displacement material 15 may alternatively be introduced, manually or automatically, at time intervals.

After agitation ceases, the method continues with 122 filtering the product from ingredients 11 that are not desired in the product through various automated or manual mechanical methods to provide the final product. The liquid extraction/product is filtered to a desired purity. This may occur through any known automated or manual mechanical methods. Filters utilized after the extraction is complete may also be necessary for use during extraction to ensure accurate readings from the sensors and other instruments. Purging the filter vessels 54 of oxygen prior to the introduction of the additional ingredient 11 to be filtered could be done automatically or manually, with or without the use of sensors, just as the oxygen was purged from the vessel 12.

Many modifications and variations of the present invention are possible in light of the above teachings and may be practiced otherwise than as specifically described while within the scope of the appended claims. These antecedent recitations should be interpreted to cover any combination in which the inventive novelty exercises its utility. The use of the word “said” in the apparatus claims refers to an antecedent that is a positive recitation meant to be included in the coverage of the claims whereas the word “the” precedes a word not meant to be included in the coverage of the claims.

What is claimed is:

1. A method for extraction, comprising:
filling a chamber of a vessel at least partially with at least one liquid ingredient;
diffusing at least one displacement material having a higher molecular mass than terrestrial air and a lower molecular mass than the liquid ingredient through at least one port located adjacent to or along a bottom surface of the vessel for releasing oxygen from the liquid ingredient;
discharging the released oxygen from the chamber through an outlet adjacent to or along a top surface of the vessel to provide a substantially anaerobic atmosphere in the chamber;
introducing at least one additional ingredient into the chamber of the vessel; and
agitating the at least one liquid ingredient and the at least one additional ingredient while maintaining the anaerobic atmosphere in the chamber.

2. The method as set forth in claim 1, wherein at least one diffusing mechanism is coupled to the at least one port to provide the diffusing of the displacement material.

3. The method as set forth in claim 2 wherein the at least one diffusing mechanism is at least one of a semi-permeable membrane.

4. The method as set forth in claim 2 wherein the chamber of the vessel has a first area in a horizontal direction, and wherein the at least one diffusing mechanism extends across at least a majority of the first area of the vessel in order to evenly distribute the at least one displacement material across the chamber of the vessel.

5. The method as set forth in claim 1, wherein the at least one displacement material is argon.

6. The method as set forth in claim 1 wherein diffusing the at least one displacement material includes modulating a pressure of the at least one of the displacement materials as it enters the chamber.

7. The method as set forth in claim 1, wherein agitating the at least one liquid ingredient and the at least one additional ingredient includes rotating at least one paddle in the chamber.

8. The method as set forth in claim 1 further including measuring an oxygen level in the chamber with at least one oxygen sensor and emitting the at least one displacement material into the chamber until the measured oxygen level has reached a predetermined level.

9. The method as set forth in claim 8 wherein the at least one oxygen sensor includes at least one oxygen sensor located adjacent to the bottom surface of the vessel for measuring an oxygen level in the liquid ingredient, and at least one oxygen sensor located adjacent to the top surface of the vessel for measuring an oxygen level above the liquid ingredient.

10. The method as set forth in claim 1 wherein a check valve is located in the outlet for allowing the oxygen to be released from the chamber while preventing air from entering the chamber.

11. The method as set forth in claim 1 further including diffusing the at least one displacement material into the chamber while the at least one liquid ingredient and the at least one additional ingredient are agitated.

12. The method as set forth in claim 1 wherein the liquid ingredient is maintained at a temperature of less than approximately 90 degrees Fahrenheit and above 32 degrees Fahrenheit throughout the substantially the entire process.

13. A system of extraction, comprising:
a vessel having a top surface and a bottom surface and defining a chamber for containing at least one liquid ingredient and at least one additional ingredient;
an agitator for agitating the at least one liquid ingredient and the at least one additional ingredient;
at least one port defined adjacent to or along the bottom surface and connected to a source of a displacement material having a higher molecular mass than terrestrial air and a lower molecular mass than the at least one liquid ingredient; and
a diffusion mechanism coupled with the at least one port for distributing the at least one displacement material through the at least one liquid ingredient contained in the chamber in order to minimize dissolved oxygen in the at least one ingredient.

14. The system as set forth in claim 13, wherein chamber of the vessel has a first area in a horizontal direction, and wherein the diffusing mechanism is configured to distribute the at least one diffusing material across at least a majority of the first area.

15. The system as set forth in claim 13, wherein the at least one diffusing material is argon.

16. The system as set forth in claim 13, wherein the at least one diffusing mechanism is at least one of a semi-permeable membrane.

17. The system as set forth in claim 13, wherein the at least one diffusing mechanism includes a plurality of perforations for emitting the gas, and wherein each of the perforations has a diameter of less than 100 microns.

18. The system as set forth in claim 13 wherein the top surface of the vessel defines an outlet for allowing oxygen to escape from the chamber.

19. The system as set forth in claim 18 wherein a check valve is located in the outlet for allowing the oxygen to be released from the chamber while preventing air from entering the chamber.

20. The system as set forth in claim 13 wherein the agitator includes at least one paddle rotatably mounted in the chamber for agitating the at least one ingredient
